(19) United States
(12) Patent Application Publication
(10) Pub. No.: US 2026/0066773 A1
(43) Pub. Date: Mar. 5, 2026

(54) LOW VOLTAGE RIPPLE AUTO PULSE SKIPPING MODE CONTROL

(71) Applicant: Novatek Microelectronics Corp., Hsinchu (TW)

(72) Inventors: Tzu-Hsien Yang, Hsinchu County (TW); Yung-Chou Lin, Hsinchu County (TW)

(73) Assignee: Novatek Microelectronics Corp., Hsinchu (TW)

(21) Appl. No.: 19/313,728

(22) Filed: Aug. 28, 2025

Related U.S. Application Data
(60) Provisional application No. 63/688,306, filed on Aug. 29, 2024.

(51) Int. Cl. H02M 1/14; H02M 1/088; H02M 3/158

(52) U.S. Cl. CPC H02M 1/14; H02M 1/088; H02M 3/158

(57) ABSTRACT

Voltage converter of the disclosure automatically and dynamically adjusts the on-time of the driving signal for driving the switch circuit, so that the charging and discharging period of an inductor is optimized. The voltage converter includes a pulse skipping modulation (PSM) control circuit, a duty generator, a switch driving circuit, and a switching circuit. The PSM control circuit is configured to generate a skip signal based on the driving signal and the clock signal, so as to dynamically and automatically adjust the on-time of the driving signal.

### CROSS-REFERENCE TO RELATED APPLICATION

This application claims priority to U.S. Provisional Application No. 63/688,306, filed Aug. 29, 2024, titled “Low Voltage Ripple Auto Pulse Skipping Mode Control Circuit”, which is hereby incorporated by reference in its entirety.

### BACKGROUND

### Technical Field

The invention relates to a voltage converter, and more specifically, a voltage converter having a low voltage ripple auto pulse skipping mode control.

### Description of Related Art

Power supplies and voltage converters are used in a variety of electronic systems. Electrical power is generally transmitted over long distances as an alternating current (AC) signal. Modern electronic systems often employ devices or components designed to operate using different DC voltages.

Pulse Skipping Modulation (PSM) is a technique used in voltage converters, particularly at light load conditions, to improve efficiency by reducing switching losses. The PSM works by selectively skipping pulses in the switching waveform, reducing the number of times the power switch turns on and off. Conventionally, the voltage converter includes a PSM control logic for determining the timing for entering the PSM mode. The PSM control logic compares an early voltage corresponding to feedback of an output voltage with a fixed threshold voltage. When the early voltage is less than the threshold voltage, the PSM control logic outputs a skip signal to a switching driver for enabling the PSM mode. However, the switching frequency changes dynamically, and the fixed threshold voltage is unable to adapt to frequent changes of the switching frequency. As such, the output voltage may have greater output voltage ripple. Further, changes in the early voltage may be small. When difference between the early voltage and the fixed threshold voltage is small, the PSM control logic would be more vulnerable to electrical noise. These electrical noises may produce double pulses, which causes output voltage ripples.

### SUMMARY

The invention is directed to a Pulse Skipping Modulation (PSM) control that reduces switching loss and output voltage ripple by dynamically and automatically adjust a skip signal that enables the PSM mode of a voltage converter.

In embodiments of the disclosure, voltage converter includes a duty generator, a switch driving circuit, a switching circuit, and a pulse control circuit. The duty generator is coupled to a clock signal and a feedback voltage and generates a duty signal according to the clock signal and the feedback voltage. The switch driving circuit is coupled to the duty generator and generates a driving signal according to the duty signal and a skip signal. The switching circuit is coupled to the switch driving circuit, an input voltage and a ground voltage. The switching circuit generates a switch node voltage according to the driving signal, which is provided to an inductor, where the switch node voltage alternatively changes between the input voltage and the ground voltage. The pulse control circuit is coupled to the switch driving circuit and the clock signal and generates the skip signal according to the clock signal and the driving signal, and then outputs the skip signal to the switch driving circuit to adjust an on-time of the driving signal.

In one of the embodiments, the pulse control circuit is configured to adjust charging and discharging period of the inductor to be within one clock cycle by adjusting a pulse occurrence within the skip signal.

In one of the embodiments, the pulse control circuit is configured to adjust the pulse occurrence within the skip signal based on a voltage level of the driving signal at a transition of the clock signal.

In one of the embodiments, when the pulse control circuit determines that the driving signal is at an inactive voltage level at a rising edge of the clock signal, the pulse control circuit extends the on-time of the driving signal for driving the switching circuit by increasing a pulse skip modulation (PSM).

In one of the embodiments, the pulse control circuit includes an on-time modulator. The on-time modulator includes a plurality of current sources, a PSM adjustment circuit, a counter, and a comparator. The plurality of current sources is coupled in parallel between a voltage source and the ground voltage and configured to output a PSM voltage. The PSM adjustment circuit is configured to receive the clock signal and the driving signal and output an up-down signal according to a voltage level of the driving signal with respect to the clock signal. The counter is coupled between the PSM adjustment circuit and the plurality of current sources. The counter is configured to enable a number of the plurality of current sources according to the up-down signal. The comparator is coupled to the plurality of current sources for receiving the PSM voltage and configured to generate the skip signal according to the feedback voltage and the PSM voltage.

In one of the embodiments, the comparator compares the PSM voltage to an early voltage corresponding to the feedback voltage, wherein the early voltage is generated by comparing the feedback voltage and a predetermined reference voltage.

In one of the embodiments, the pulse control circuit starts outputting the skip signal (SKIP) when the PSM voltage is greater than the early voltage.

In one of the embodiments, the pulse control circuit further includes a noise margin generator. The noise margin generator is coupled between the on-time modulator and the comparator. The noise margin generator includes an amplifier, a voltage source, a first switch and a second switch. The amplifier includes a first terminal, a second terminal and an output terminal coupled to the first terminal. The voltage source, having a predetermined margin voltage is coupled between the second terminal of the amplifier and the current sources of the on-time modulator. The first switch is coupled between the output terminal of the amplifier and the second terminal of the comparator and having a control terminal coupled to the driving signal or the duty signal. The second switch is coupled between the current sources of the on-time modulator and the second terminal of the comparator and having a control terminal coupled to an inverted driving signal or an inverted duty signal.

In embodiments of the disclosure includes a voltage converter configured to receive an input voltage and generate an output voltage. The voltage converter includes an output inductor, a switching circuit, a switch driving circuit, and a pulse skipping mode (PSM) control circuit. The output inductor includes a first terminal and a second terminal, and configured to charge and discharge according to the input voltage. The switching circuit is coupled to the input voltage, the first terminal of the output inductor, and a ground voltage and configured to switch between a first state and a second state, wherein the switching circuit couples the input voltage to the output inductor to charge the output inductor in the first state and couples the output inductor to the ground voltage to discharge the output inductor in the second state. The switch driving circuit is configured to output a driving signal to control the switching circuit to switch between the first state and the second state according to a duty signal and a skip signal. The pulse skipping mode (PSM) control circuit is coupled to the second terminal of the output inductor and configured to dynamically generate the skip signal according to a feedback voltage corresponding to the output voltage and a clock signal.

In one of the embodiments, the PSM control circuit includes a comparator having a first terminal, a second terminal and an output terminal, wherein the first terminal is coupled to the feedback voltage corresponding to the output voltage, the second terminal is coupled to an error amplifier, and the output terminal is coupled to the switch driving circuit.

In one of the embodiments, the PSM control circuit further includes a PSM adjustment circuit, a plurality of current sources, and an up-down counter. The PSM adjustment circuit is configured to receive the clock signal and the driving signal and output a up-down signal according to the clock signal and the driving signal. The current sources are coupled to each other in parallel between a first source voltage and a second source voltage, and configured to output a PSM voltage depending a number of the current sources being enabled. The up-down counter is coupled to the PSM adjustment circuit and the plurality of current sources and configured to enable a number of the current sources according to the up-down signal received from the PSM adjustment circuit. In the embodiment, the PSM voltage is coupled to the second terminal of comparator.

In one of the embodiments, the PSM control circuit further includes a PSM adjustment circuit, a current source, an amplifier, a first switch, and a second switch. The PSM adjustment circuit is coupled to the clock signal and switch driving circuit for receiving the driving signal and configured to output an enable signal based on the clock signal and the driving signal. The current source is configured to outputting a PSM voltage according to the enable signal. The amplifier includes a first terminal, a second terminal and an output terminal coupled to the first terminal. The voltage source has a predetermined voltage. The voltage source is coupled between the second terminal of the amplifier and the PSM voltage. The first switch is coupled between the output terminal of the amplifier and the second terminal of the comparator. The first switch has a control terminal coupled to a duty signal. The second switch is coupled between the current source and the second terminal of the comparator. The second switch includes a control terminal coupled to an inverted duty signal.

In one of the embodiments, the voltage converter further includes a duty generator. The duty generator is coupled to the clock signal and the second terminal of the output inductor for receiving the feedback voltage. The duty generator is configured to generate a duty signal according to the clock signal and feedback voltage and output the duty signal to the switch driving circuit.

To make the above features and advantages of the disclosure more comprehensible, several embodiments accompanied with drawings are described in detail as follows.

It should be understood, however, that this Summary may not contain all of the aspects and embodiments of the present invention, is not meant to be limiting or restrictive in any manner, and that the invention as disclosed herein is and will be understood by those of ordinary skill in the art to encompass obvious improvements and modifications thereto.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram illustrating a voltage converter according to one of the embodiments of the disclosure.

FIGS. 2A-2B are timing diagrams illustrating an adjustment of charging and discharging period of an inductor based on a driving signal with respect to a clock signal according to one of the embodiments of the disclosure.

FIG. 3A is a diagram illustrating a voltage converter according to one of the embodiments of the disclosure.

FIG. 3B is a diagram illustrating a voltage converter according to one of the embodiments of the disclosure.

FIG. 4A is a diagram illustrating a voltage converter according to one of the embodiments of the disclosure.

FIG. 4B is a diagram illustrating a voltage converter according to one of the embodiments of the disclosure.

FIG. 5 is a diagram illustrating an on-time modulator 513 according to one of the embodiments of the disclosure.

FIG. 6 is a timing diagram illustrating an adjustment of the PSM voltage VPSM according to one of the embodiments of the disclosure.

FIG. 7 is a diagram illustrating a PSM control circuit 711 according to one of the embodiments of the disclosure.

FIG. 8 is a timing diagram illustrating an operation of the noise margin generator 715 according to one of the embodiments of the disclosure.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Embodiments of the present invention may comprise any one or more of the novel features described herein, including in the Detailed Description, and/or shown in the drawings. As used herein, “at least one,” “one or more” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein.

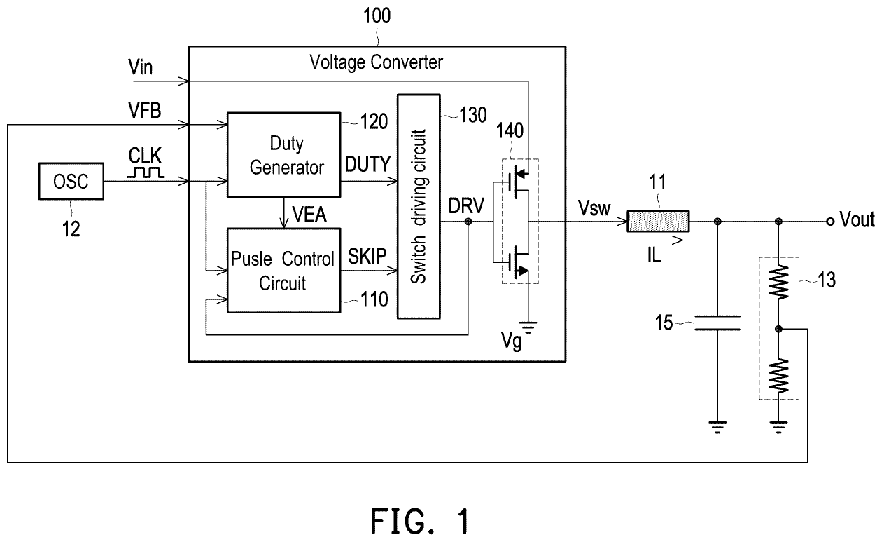

FIG. 1 is a diagram illustrating a voltage converter 100 according to one of the embodiments of the disclosure. The voltage converter 100 includes a pulse skipping modulation (PSM) control circuit 110, a duty generator 120, a switch driving circuit 130, and a switching circuit 140. The voltage converter 100 receives an input voltage Vin and generates a switch node voltage Vsw. The voltage converter 100 is coupled to an inductor 11 for generating an output voltage Vout based on the switch node voltage Vsw. At an output end of the inductor 11, the inductor 11 is coupled to an output voltage feedback circuit 13 and a coupling capacitor 15. In the disclosure, the voltage converter 100 may also be referred to as a power converter or a DC-DC converter.

Instead of generating a skip signal for enabling a PSM mode based on a fixed threshold voltage, the pulse control circuit 110 is provided for dynamically and automatically generating the skip signal based on an occurrence and/or an on-time (pulse width) of a driving signal DRV with respect to a clock signal CLK. In the convention art, the fixed threshold voltage is compared to an early voltage representing an output voltage of a conventional voltage converter. Since a switching element of the conventional voltage converter switches based on a clock signal, the inductor may not have sufficient time to charge or discharge when the PSM mode is enabled based on the skip signal generated based on the fixed threshold voltage. Therefore, the conventional voltage converter suffers from switching loss, output voltage ripples, electrical noise, etc. On the contrary, the voltage converter 100 of the embodiments optimizes the charging and discharging period of an inductor at an output stage of voltage converter 100 by adjusting the skip signal. Details of the pulse control circuit 110 would be described later.

The duty generator 120 is coupled to a clock signal CLK generated by a clock oscillator (OSC) 12 and a feedback voltage VFB generated by the output voltage feedback circuit 13. Based on the clock signal CLK and the feedback voltage VFB, the duty generator 120 generates a duty signal DUTY according to the clock signal CLK and the feedback voltage VFB. The duty generator 120 outputs the duty signal DUTY to the switch driving circuit 130.

The switch driving circuit 130 is coupled to the pulse control circuit 110 and the duty generator 120. Based on the duty signal DUTY and the skip signal DRV, the switching driving circuit 130 generates a driving signal DRV for driving the switching circuit 140.

The switching circuit 140 is coupled to the switch driving circuit 130, an input voltage Vin and a ground voltage Vg. In the embodiment, the switching circuit 140 includes a pair of N-channel MOSFET (NMOS) and a P-channel MOSFET (PMOS) coupled in series between the input voltage Vin and the ground voltage Vg. The switch driving circuit 130 is controlled by the driving signal DRV output by the switch driving circuit 130 and outputs a switch node voltage Vsw. The switch node voltage Vsw alternatively changes between the input voltage Vin and the ground voltage Vg. The switch node voltage Vsw is provided to inductor 11 for charging and discharging the inductor 11, where the inductor 11 is coupled to an output voltage feedback circuit 13 and an output capacitor 14. In the embodiment, the output voltage feedback circuit 13 may include a voltage divider having two resistors coupled between the output voltage Vout and the ground voltage Vg for acquiring a feedback voltage VFB reflecting the output voltage Vout.

The pulse control circuit 110 is coupled to the clock signal CLK and the switch driving circuit 130. In the embodiment, the pulse control circuit 110 generates the skip signal SKIP based on the clock signal CLK and the driving signal DRV. Then, the skip signal SKIP is output to the switch driving circuit 130 to adjust an on-time of the driving signal DRV. In one of the embodiments, the pulse control circuit 110 determines a voltage level of the driving signal DRV at a rising edge of the clock signal CLK. Based on the voltage level of the driving signal DRV at the rising edge of the clock signal CLK, the pulse control circuit 110 adjust an occurrence of the skip signal SKIP, so as to adjust the on-time of the driving signal DRV. The adjustment of the driving signal DRV may include changing the timing at which the skip signal SKIP occurs with respect to the clock signal CLK. The adjustment to the occurrence of the skip signal SKIP may also be referred to an adjustment of a pulse occurrence within the skip signal. In other embodiments, the adjustment of the driving signal DRV includes extending or shortening of a pulse width or an on-time of the skip signal SKIP, so as to extending or shortening the on-time of the driving signal DRV. It should be noted that these embodiments may also be combined, where both the occurrence and on-time of the skip signal SKIP may be utilized to adjust the driving signal DRV.

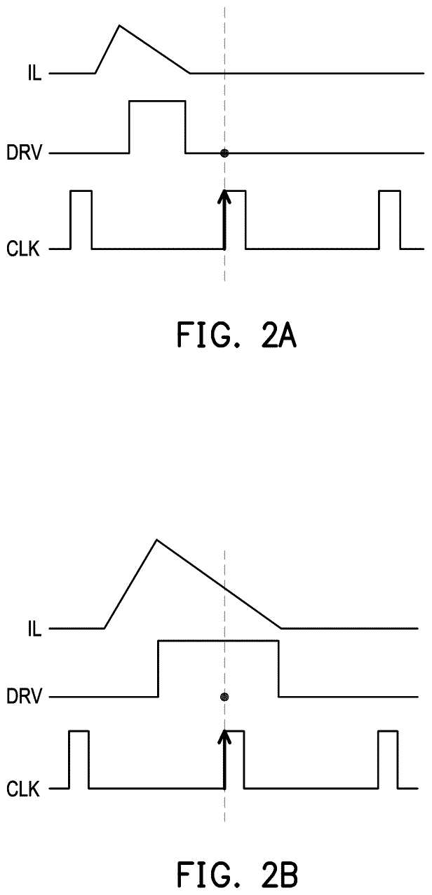

FIGS. 2A-2B are timing diagrams illustrating an adjustment of the charging and discharging period of the inductor 11 based on the driving signal DRV with respect to the clock signal CLK according to one of the embodiments of the disclosure. The pulse control circuit 110 monitors the voltage level of the driving signal DRV at the rising edge of the clock signal CLK. With reference to FIG. 2A, if the driving signal DRV is at a voltage level representing a logic low at the rising edge of the clock signal CLK, the on-time of the driving signal DRV is too short. In such scenario, the one-time of the driving signal DRV should be extended, so that charging and discharging period of the inductor 11 may be optimized. With reference to FIG. 2B, if the driving signal DRV is at voltage level representing a logic high at the rising edge of the clock signal CLK, the on-time of the driving signal DRV is too long. In such scenario, the one-time of the driving signal DRV should be shorten, so that the charging and discharging period of the inductor 11 may be optimized. It should be noted that energy may be represented by an area of the triangle waveform of an inductor current IL flowing through the inductor 11. When the on-time of the driving signal DRV is too short with respect to the clock signal CLK, the area of the triangle waveform as illustrated in FIG. 2A is smaller than the area of the triangle waveform as illustrated in FIG. 2B. That is, the inductor 11 is not fully charged and discharged within a switching cycle of the switching circuit 140 when the driving signal DRV is not enabled at an optimal start time or the on-time of the driving signal DRV is not optimized. As such, the switching circuit 140 may switch frequently, which causes switching loss and output voltage ripples. The embodiments of the disclosure is to optimize the charging and discharging period of the inductor 11, so that the charging and discharging period of the inductor 11 occurs within one clock cycle. That is, the pulse control circuit 110 adjusts the occurrence and\or on-time of the skip signal SKIP for adjusting the occurrence and on-time of the driving signal DRV which controls the timing of operation of the switching circuit 140.

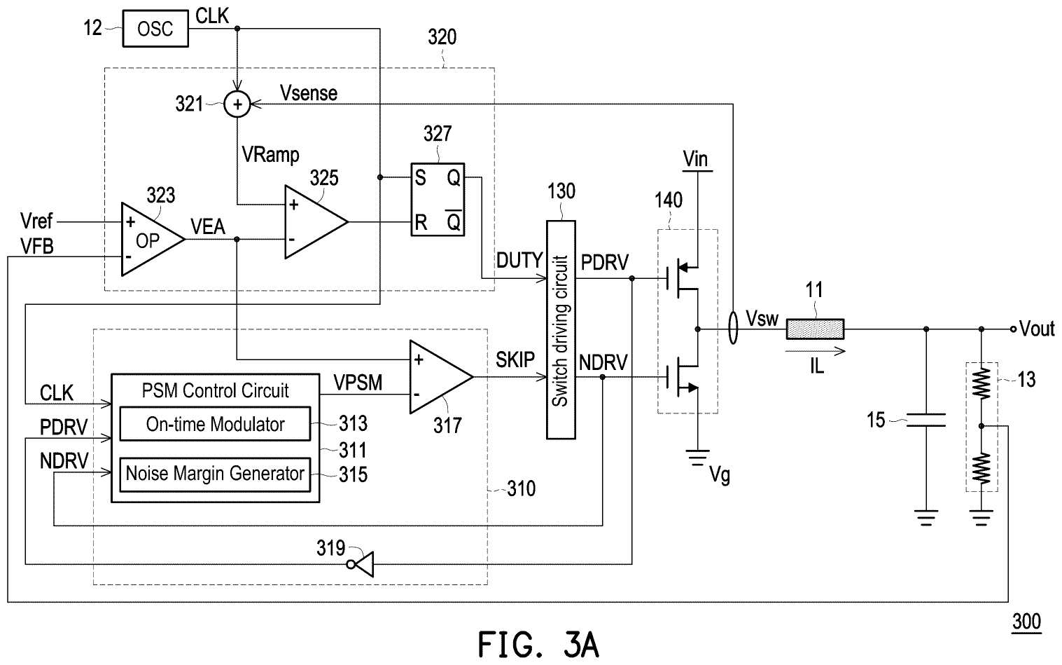

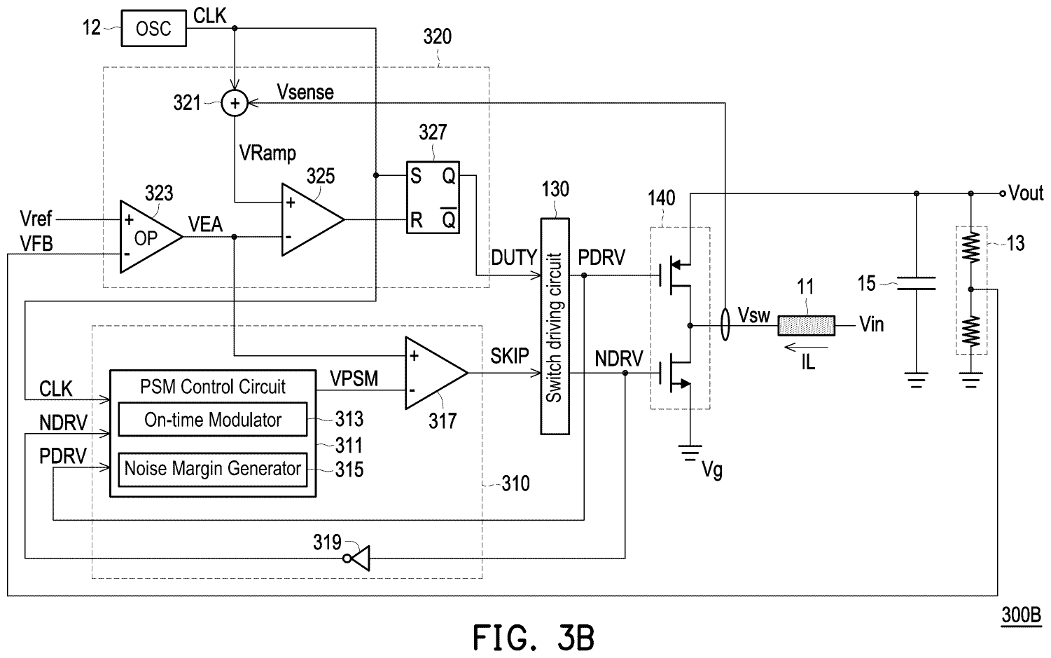

FIG. 3A is a diagram illustrating a voltage converter 300 according to one of the embodiments of the disclosure. The voltage converter 300 a PSM control circuit 310, a duty generator 320, the switch driving circuit 130, and the switching circuit 140. Similar to the voltage converter 100 illustrated in FIG. 1, the voltage converter 300 receives an input voltage Vin and generates a switch node voltage Vsw. The voltage converter 300 is coupled to an inductor 11 for generating an output voltage Vout based on the switch node voltage Vsw. Different from the voltage converter 100, the driving signal DRV includes a first driving signal and a second driving signal, where the first driving signal may be referred to as a NMOS driving signal NDRV and the second driving may be referred to as a PMOS driving signal PDRV. The PMOS driving signal PDRV and the NMOS driving signal NDRV respectively controls the PMOS transistor and the NMOS transistor of the switching circuit 140.

Furthermore, the PSM control circuit 310 is different from the PSM control circuit 110 illustrated in FIG. 1. The PSM control circuit 310 includes a PSM control circuit 311, a comparator 317, and an inverter 319. The PSM control circuit 311 receives the clock signal CLK, an inverted PMOS driving signal PDRV and a NMOS driving signal NDRV and outputs a PSM voltage VPSM based on the clock signal CLK, the inverted PMOS driving signal PDRV and the NMOS driving signal NDRV. The inverted PMOS driving signal PDRV is generated by the inverter 319 coupled to the PMOS driving signal output by the switch driving circuit 130. The comparator 317 includes a first terminal coupled to an output terminal of the PSM control circuit 311 for receiving a PSM voltage VPSM and a second terminal coupled to the duty generator 320 for receiving the early voltage VEA. The comparator 317 generates the skip signal SKIP based on the early voltage VEA and the PSM voltage VPSM. As described above, conventional art generates a skip signal SKIP based on the early voltage VEA corresponding to the feedback voltage VFB and a fixed threshold voltage. In the embodiment, the skip signal SKIP is generated based on the early voltage VEA and the PSM voltage VPSM. The PSM voltage VPSM is dynamically generated based on the driving signals NDRV, PDRV and the clock signal.

With reference to FIG. 3A, the PSM control circuit 311 includes an on-time modulator 313 and a noise margin generator 315, which are configured to dynamically adjust an on-time of the driving signal NDRV, PDRV through the skip signal SKIP which is generated based on the PSM voltage VPSM. In the embodiment, the PSM voltage VPSM is generated based on the driving signal NDRV, PDRV with respect to the clock signal as described in FIGS. 2A-2B through the on-time modulator 313 and/or the noise margin generator 315. It should be noted that the on-time modulator 313 and the noise margin generator 315 may be utilized independently or in a combination for adjusting the occurrence of the skip signal SKIP and the pulse width of the skip signal SKIP. The detail of the on-time modulator 313 and the noise margin generator 315 would be illustrated later.

With reference to FIG. 3A, the duty generator 320 includes an adder 321, an error amplifier 323, a comparator 325, and a latch 327. The adder 321 receives the clock signal CLK and a sensed voltage Vsense, where the sensed voltage Vsense is a representative of an inductor current IL. The adder 321 outputs a ramp voltage VRamp based on the clock signal CLK and the sensed voltage Vsense. The error amplifier 323 receives a reference voltage Vref and the feedback voltage VFB, where the feedback voltage VFB is a representative of the output voltage Vout of the voltage converter 300. The error amplifier 323 outputs the early voltage VEA. The comparator 325 receives the ramp voltage VRamp and the early voltage VEA. The latch 327 outputs the duty signal DUTY based on the clock signal CLK and a comparison result of the ramp voltage VRamp and the early voltage VEA. For example, the latch 327 may output a logic high until the comparator 325 detects that the ramp voltage VRamp is greater than the early voltage VEA. It should be noted that the architecture of the duty generator 320 is merely an embodiment. The disclosure is not intended to limit thereto. Various architecture for generating duty signal DUTY in the art should still be deemed to fall within the scope of the disclosure.

The switch driving circuit 130 receives the duty signal DUTY generated by the duty generator 320 and the skip signal SKIP generated by the pulse control circuit 310. Based on the duty signal DUTY and the skip signal SKIP, the switch driving circuit 130 generates the switch driving signals PDRV, NDRV for driving the switching circuit 140, where the switching circuit 140 generates the switch node voltage Vsw that alternatively changes between the input voltage Vin and the ground voltage Vg.

It should be noted that the voltage converter 300 of FIG. 3A is illustrated as a buck converter, however, the adjustment of the driving signal also applies to a voltage converter configured as a boost converter. FIG. 3B is a diagram illustrating a voltage converter 300B according to one of the embodiments of the disclosure. In the configuration of boost converter, the PSM control circuit 311 generates the PSM voltage VPSM based on the clock signal CLK, the PMOS driving signal PDRV and\or an inverted NMOS driving signal NDRV. In FIG. 3A, the inverter 319 is coupled between the PSM control circuit 311 and the PMOS driving signal PDRV. On the other hand, in FIG. 3B, the inverter 319 is coupled between the PSM control circuit 311 and the NMOS driving signal NDRV. The operations of the voltage converter 300B illustrated in FIG. 3B should be similar to the operations of the voltage converter 300 illustrated in FIG. 3A, and thus the detail of which are omitted here.

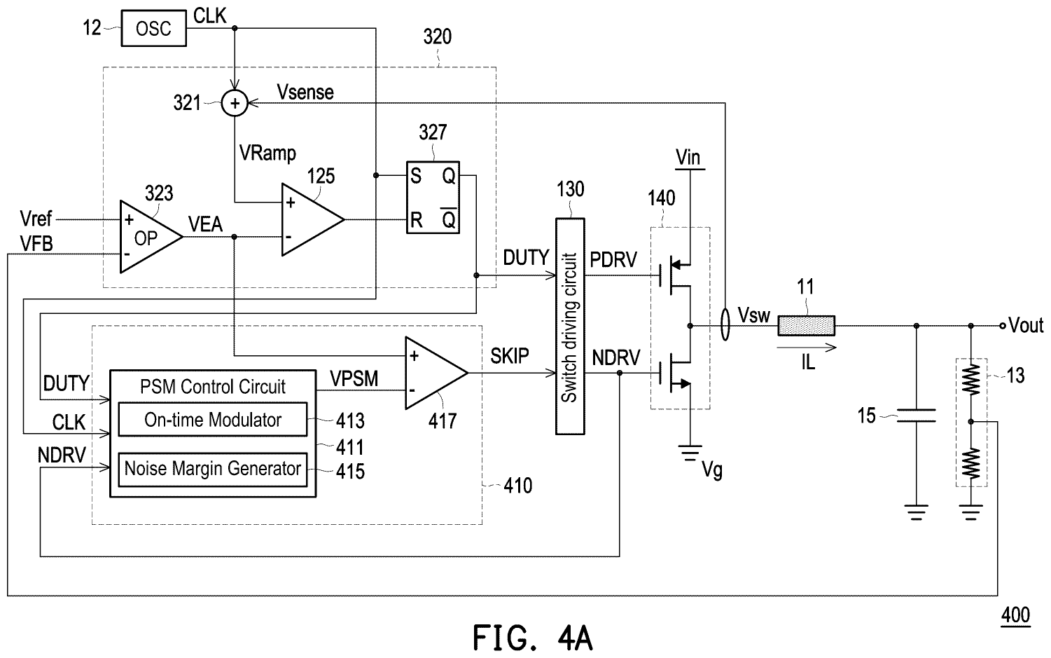

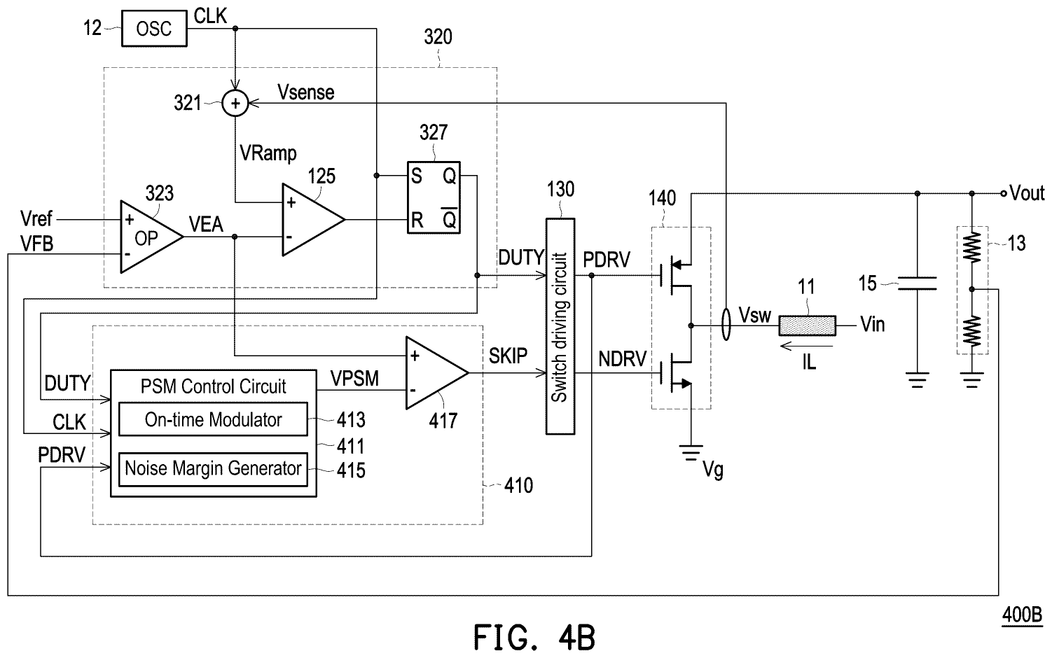

FIG. 4A is a diagram illustrating a voltage converter 400 according to one of the embodiments of the disclosure. The voltage converter 400 includes a PSM control circuit 410, the duty generator 320, the switching driving circuit 130, and the switching circuit 140. In the embodiment, the duty generator 320, the switching driving circuit 130, and the switching circuit 140 are similar to the above embodiments, and thus the detail of which are omitted here for the purpose of brevity.

With reference to FIG. 4A, the PSM control circuit 410 is coupled to the duty generator 320 to receive the duty signal DUTY. Different from the embodiment illustrated in FIG. 3A, the PSM control circuit 410 is coupled to the duty signal DUTY, rather than the inverted PMOS driving signal PDRV as illustrated in the embodiment illustrated in FIG. 3A. That is, the PSM voltage VPSM may be adjusted by the duty signal DUTY generated by the duty generator 320, rather than the inverted PMOS driving signal PDRV in FIG. 3A.

It should be noted that the voltage converter 400 of FIG. 4A is illustrated as a buck converter, however, the adjustment of the driving signal also applies to a voltage converter configured as a boost converter. FIG. 4B is a diagram illustrating a voltage converter 400B according to one of the embodiments of the disclosure. The operations of the voltage converter 400B illustrated in FIG. 4B should be similar to the operations of the voltage converter 400 illustrated in FIG. 4A, and thus the detail of which are omitted here.

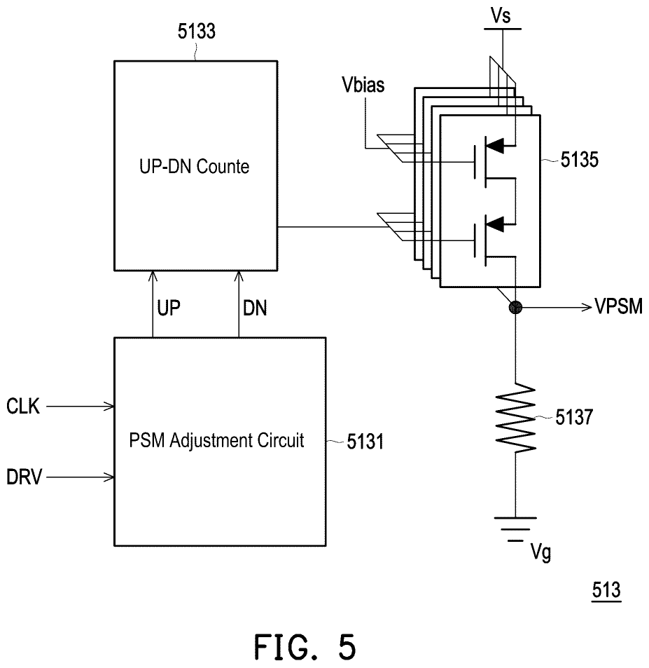

FIG. 5 is a diagram illustrating an on-time modulator 513 according to one of the embodiments of the disclosure. The on-time modulator 513 may be applied as the pulse control circuit 110, the on-time modulator 313, or the on-time modulator 413 described above. In the embodiment, the on-time modulator 513 includes a PSM adjustment circuit 5131, an up-down counter 5133, a plurality of current sources 5135, and a resistor 5137.

The PSM adjustment circuit 5131 is coupled to the up-down counter 5133. The up-down counter 5133 is coupled to the plurality of current sources 5135 to enable or disable the number of the current sources 5135. The plurality of current sources 5135 are coupled to a bias voltage Vbias. The plurality of current sources 513 are coupled between a source voltage Vs and the ground voltage Vg and output a voltage as the PSM voltage VPSM according to the number of the current sources 5135 that is been enabled by the up-down counter 5133. The resistor 5137 is coupled between the plurality of current sources 5135 and the ground voltage Vg.

In the embodiment, the PSM adjustment circuit 5131 receives the clock signal CLK and the driving signal DRV. As illustrated in FIGS. 2A-2B, the PSM adjustment circuit 5131 adjusts the driving signal DRV based on a transition of the clock signal CLK. The PSM adjustment circuit 5131 outputs an up-count value UP or a down-count value DN to the up-down counter 5133 for adjusting the number of the current sources 5135, so as to adjust the PSM voltage VPSM. In the embodiment, the driving signal DRV is compared to a rising edge of the clock signal CLK. However, the disclosure is not limited thereto, the comparison may be performed based on a falling edge of the clock signal CLK.

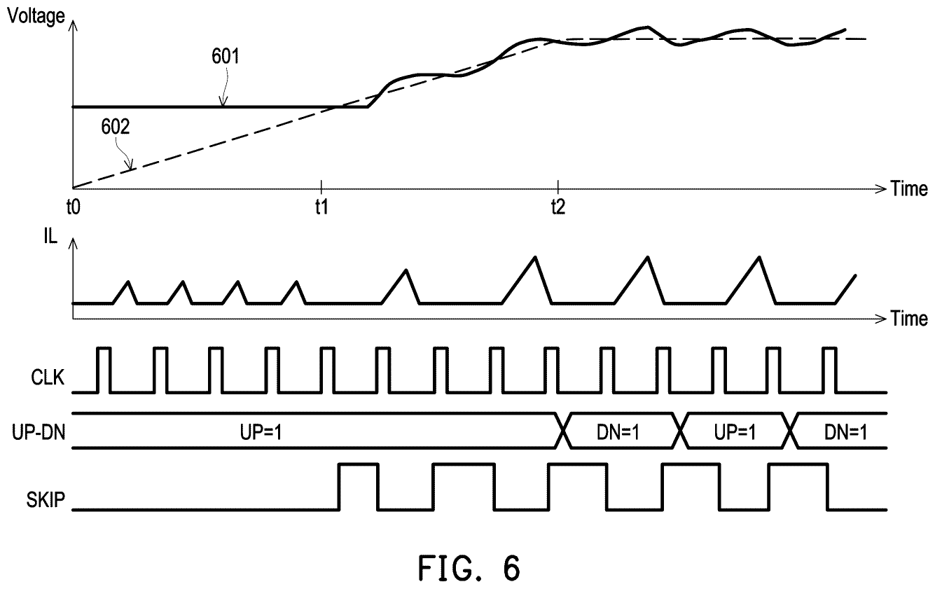

FIG. 6 is a timing diagram illustrating an adjustment of the PSM voltage VPSM according to one of the embodiments of the disclosure. In FIG. 6, a first curve 601 represents the early voltage VEA and a second curve 602 represents the PSM voltage VPSM.

Between time t0 and time t1, the charging and discharging period of the inductor represented by an inductor current IL is less than a clock cycle. Therefore, the output energy (e.g., area of the triangle waveform of the inductor current IL) is small in each clock cycle between time t0 and time t1. With reference to FIGS. 2A, 5 and 6, the driving signal DRV is off with respect to the rising edge of the clock signal between time t0 and time t1. Accordingly, the PSM adjustment circuit 5131 would output an up-count value (i.e., UP=1) to the up-down counter 5133 until the driving signal DRV is on at the rising edge of the clock signal CLK (FIG. 2B.) When up-count value equal to 1, the second curve 602 increases. In other words, the PSM voltage VPSM increases due to a higher number of the current sources 5135 is enabled.

At time t1, the PSM voltage VPSM becomes greater than the early voltage VEA, and the skip signal SKIP is enabled. With reference to FIG. 3A-3B or 4A-4B, the comparator 317, 417 outputs the skip signal SKIP based on the early voltage VEA and the PSM voltage VPSM. Between the time t1 and time t2, the early voltage VEA increases with the PSM voltage VPSM, which increases the on-time of the driving signal DRV (NDRV or PDRV) generated by the switch control circuit 130. The driving signal DRV controls the switching period of the switch circuit 140, which changes the amount of time for the switch node voltage Vsw is provided to the inductor 11. Accordingly, the charging and discharging period of the inductor 11 is adjusted. During the adjustment period between time t1 and time t2, the occurrence of the skip signal SKIP, the pulse width of the skip signal SKIP, or a pulse occurrence within the skip signal is adjusted due to the adjustment on the driving signal DRV (NDRV or PDRV.)

At time t2, the charging and discharging period of the inductor 11 is falls within one clock cycle. The PSM adjustment circuit 5131 outputs the down-count values (e.g., DN=1, UP=0) to decrease the number of the current sources 5135 being enabled. As such, the charging and discharging of the inductor 11 is optimized, where the area of the triangle waveform of the inductor current IL is optimized. In the embodiment, after time t2, the PSM adjustment circuit 5131 outputs the up-count value and the down-count value alternative to maintain the optimization of the charging and discharging of the inductor 11. However, the disclosure is not limited thereto. In other embodiments, the PSM adjustment circuit 5131 may output zero for both the up-count value and the down-count value, so that the number of the current sources may remain the same.

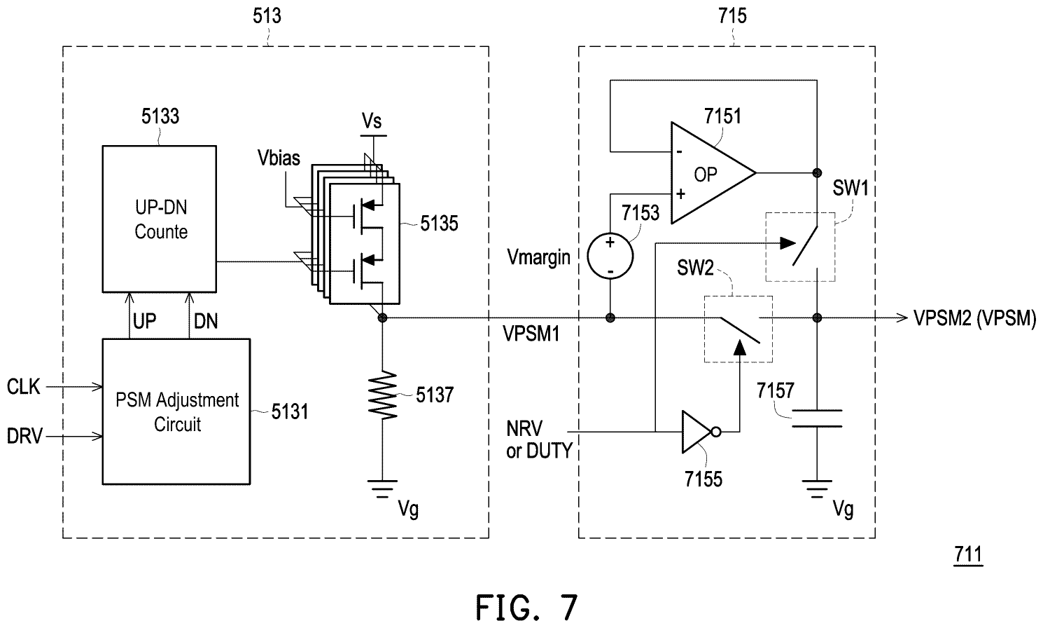

FIG. 7 is a diagram illustrating a PSM control circuit 711 according to one of the embodiments of the disclosure. The PSM control circuit 711 may be applied as the pulse control circuit 110, the PSM control circuit 311, and the PSM control circuit 411 described above. In the embodiment, the PSM control circuit 711 further includes a noise margin generator 715 subsequent to the on-time modulator 513 to fine tune the PSM voltage PSM. In the embodiment, the PSM voltage VPSM may include a first PSM voltage VPSM1 and a second PSM voltage VPSM2. The first PSM voltage VPSM1 represents an output of the on-time modulator 513, and the second PSM voltage VPSM2 represents an output of the noise margin generator 715. The noise margin generator 715 is configured to add a margin voltage Vmargin that has the same phase as the inductor current IL to the first PSM voltage VPSM1, so as to increase noise margin and reduce the delay time of the comparator of the pulse control circuit.

The noise margin generator 715 includes an amplifier 7151, a voltage source 7153, an inverter 7155, a capacitor 7157, and a first switch SW1 and a second switch SW2. The amplifier 7151 includes a first terminal coupled to an output terminal of the amplifier 7151 and a second terminal coupled to a first terminal of the voltage source 7153. The voltage source 7153 includes a second terminal coupled to current sources 5135 of the on-timer modulator 513 and a first terminal of the amplifier 7151. The second switch SW2 includes a first terminal coupled to the voltage source 5153, a second terminal coupled to a junction node, and a control terminal coupled to the driving signal DRV or duty signal DUTY through the inverter 7155. The first switch SW1 has a first terminal coupled to the output terminal of the amplifier 7151, a second terminal coupled to the junction node, and a control terminal coupled to the driving signal DRV or duty signal DUTY. The capacitor 7157 is coupled between the junction node and the ground voltage Vg. The voltage at the junction node is an output of the noise margin generator 715, which would be the PSM voltage VPSM coupled to the comparator 317, 417.

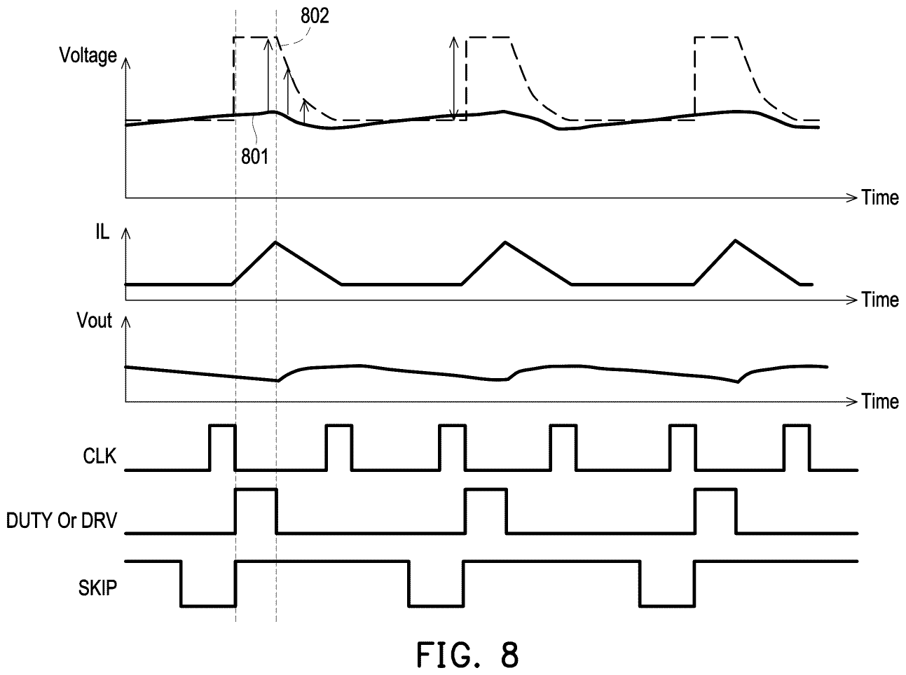

FIG. 8 is a timing diagram illustrating an operation of the noise margin generator 715 according to one of the embodiments of the disclosure. In FIG. 8, a first curve 801 represents the early voltage VEA, and a second curve 802 represents the PSM voltage VPSM. With reference to FIG. 3A (or 3B-4A), the comparator 317 (or 417) compares the early voltage VEA and the PSM voltage VPSM. However, when the value of the early voltage VEA is close to the value of the first PSM voltage VPSM1, the adjustment of the driving signal DRV may suffer from electrical noise. When the difference between the early voltage VEA and the PSM voltage VPSM may not be sufficient, the comparator 317 (or 417) may misjudge the situation when electrical noise added to the signals. The noise margin generator 715 adds the margin voltage Vmargin to the first PSM voltage VPSM1 to increase the difference between the early voltage VEA and the second PSM voltage VPSM2.

With reference to FIGS. 7 and 8, when the duty signal DUTY or the driving signal DRV is high, the first switch SW1 is enabled and the second switch SW2 is disabled. As such, the margin voltage Vmargin of the voltage source 2153 is added to the first PSM voltage VPSM1 generated by the on-time modulator 513. In such case, the second PSM voltage VPSM2 is the first PSM voltage VPSM1 plus the margin voltage Vmargin. On the other hand, when the duty signal DUTY or the driving signal DRV is low, the first switch SW1 is disabled and the second switch SW2 is enabled. The first PSM voltage VPSM1 generated by the on-time modulator 513 would be allowed to flow through the second switch SW2 without the addition of the margin voltage Vmargin. In such case, the second PSM voltage VPSM2 is the first PSM voltage VPSM1. In the embodiment, the margin voltage Vmargin may approximately 50 mV. However, the disclosure is not intended to limit the value of the margin voltage Vmargin. In other embodiments, the margin voltage Vmargin may range from 1 mV to 100 mV. FIG. 8 illustrates that the margin voltage Vmargin boosts the first PSM voltage VPSM when the duty signal DUTY or the driving signal DRV is high, so as to create a greater voltage difference between the early voltage VEA (e.g., first curve 801) and the PSM voltage VPSM (e.g., second curve 802).

In summary, the PSM control circuit of the disclosure automatically and dynamically adjust the occurrence of the skip signal, a pulse width of the skip signal, and/or a pulse occurrence within the skip signal according to the clock signal and the driving signal for driving the switching circuit, so as to adjust the on-time of the driving signal. Other aspect of the disclosure is to increase the voltage differences between the early voltage and the PSM voltage, so as to minimize the effect of the electrical noise, reduce the delay time of the comparator that generates the skip signal, reduces output voltage ripple, etc.

Although the present invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

The previously described exemplary embodiments of the present invention have the advantages aforementioned, wherein the advantages aforementioned not required in all versions of the invention.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A voltage converter, comprising:
a duty generator, coupled to a clock signal and a feedback voltage, generating a duty signal according to the clock signal and the feedback voltage;
a switch driving circuit, coupled to duty generator, and generating a driving signal according to the duty signal and a skip signal;
a switching circuit, coupled to the switch driving circuit, an input voltage and a ground voltage, and generating a switch node voltage provided to an inductor according to the driving signal, wherein the switch node voltage alternatively changes between the input voltage and the ground voltage; and
a pulse control circuit, coupled to the switch driving circuit and the clock signal, and generating the skip signal according to the clock signal, and the driving signal, and outputting the skip signal to the switch driving circuit to adjust an on-time of the driving signal.

2. The voltage converter of claim 1, wherein the pulse control circuit is configured to adjust charging and discharging period of the inductor to be within one clock cycle by adjusting a pulse occurrence within the skip signal.

3. The voltage converter of claim 2, wherein the pulse control circuit is configured to adjust the pulse occurrence within the skip signal based on a voltage level of the driving signal at a transition of the clock signal.

4. The voltage converter of claim 3, wherein when the pulse control circuit determines that the driving signal is at an inactive voltage level at a rising edge of the clock signal, the pulse control circuit extends the on-time of the driving signal for driving the switching circuit by increasing a pulse skip modulation voltage.

5. The voltage converter of claim 1, wherein the pulse control circuit, comprises:
an on-time modulator, comprises:
a plurality of current sources, coupled in parallel between a voltage source and the ground voltage, and outputting a PSM voltage; and
a PSM adjustment circuit, receiving the clock signal and the driving signal, and outputting an up-down signal according to a voltage level of the driving signal with respect to the clock signal;
a counter, coupled between the PSM adjustment circuit and the current sources, and enabling a number of the current sources according to the up-down signal; and
a comparator, coupled to the plurality of current sources for receiving the PSM voltage, and generating the skip signal according to the feedback voltage and the PSM voltage.

6. The voltage converter of claim 5, wherein the comparator compares the PSM voltage to an early voltage corresponding to the feedback voltage, wherein the early voltage is generated by comparing the feedback voltage and a predetermined reference voltage.

7. The voltage converter of claim 6, wherein the pulse control circuit starts outputting the skip signal when the PSM voltage is greater than the early voltage.

8. The voltage converter of claim 5, wherein the pulse control circuit further comprises:
a noise margin generator, coupled between the on-time modulator and the comparator, and comprises:
an amplifier, having a first terminal, a second terminal and an output terminal coupled to the first terminal;
a voltage source, having a predetermined margin voltage, coupled between the second terminal of the amplifier and the current sources of the on-time modulator;
a first switch, coupled between the output terminal of the amplifier and the second terminal of the comparator, and having a control terminal coupled to the driving signal or the duty signal; and
a second switch, coupled between the current sources of the on-time modulator and the second terminal of the comparator, and having a control terminal coupled to an inverted driving signal or an inverted duty signal.

9. A voltage converter, receiving an input voltage and generating an output voltage, comprising:
an output inductor, having a first terminal and a second terminal, and being charged and discharged according to the input voltage;
a switching circuit, coupled to the input voltage, the first terminal of the output inductor, and a ground voltage and configured to switch between a first state and a second state, wherein the switching circuit couples the input voltage to the output inductor to charge the output inductor in the first state and couples the output inductor to the ground voltage to discharge the output inductor in the second state;
a switch driving circuit, configured to output a driving signal to control the switching circuit to switch between the first state and the second state according to a duty signal and a skip signal; and
a pulse skipping mode (PSM) control circuit, coupled to the second terminal of the output inductor, configured to dynamically generate the skip signal according to a feedback voltage corresponding to the output voltage and a clock signal.

10. The voltage converter of claim 9, wherein the PSM control circuit includes a comparator having a first terminal, a second terminal and an output terminal, wherein the first terminal is coupled to the feedback voltage corresponding to the output voltage, the second terminal is coupled to an error amplifier, and the output terminal is coupled to the switch driving circuit.

11. The voltage converter of claim 10, wherein the PSM control circuit further includes:
a PSM adjustment circuit, receiving the clock signal and the driving signal, and outputting a up-down signal according to the clock signal and the driving signal;
a plurality of current sources, coupled to each in parallel between a first source voltage and a second source voltage, and outputting a PSM voltage depending a number of the current sources being enabled;
an up-down counter, coupled to the PSM adjustment circuit and the plurality of current sources, and configured to enable a number of the current sources according to the up-down signal received from the PSM adjustment circuit,
wherein the PSM voltage is coupled to the second terminal of comparator.

12. The voltage converter of claim 10, wherein the PSM control circuit further includes:
a PSM adjustment circuit, coupled to the clock signal and switch driving circuit for receiving the driving signal, and output an enable signal based on the clock signal and the driving signal;
a current source, outputting a PSM voltage according to the enable signal;
an amplifier, having a first terminal, a second terminal and an output terminal coupled to the first terminal;
a voltage source, having a predetermined voltage, coupled between the second terminal of the amplifier and the PSM voltage;
a first switch, coupled between the output terminal of the amplifier and the second terminal of the comparator, and having a control terminal coupled to a duty signal; and
a second switch, coupled between the current source and the second terminal of the comparator, and having a control terminal coupled to an inverted duty signal.

13. The voltage converter of claim 9, further comprising:
a duty generator, coupled to the clock signal and the second terminal of the output inductor for receiving the feedback voltage, and generating a duty signal according to the clock signal and feedback voltage, outputting the duty signal to the switch driving circuit.
